(19) United States
(12) Patent Application Publication
(10) Pub. No.: US 2020/0100471 A1
(43) Pub. Date: Apr. 2, 2020

(54) PET MONITOR

(71) Applicant: Dogness Group LLC, Plano, TX (US)

(72) Inventors: Silong CHEN, Dongguan (CN); Yunhao CHEN, Plano, TX (US)

(73) Assignee: Dogness Group LLC, Plano, TX (US)

(21) Appl. No.: 16/147,598

(22) Filed: Sep. 29, 2018

(51) Int. Cl. A01K 29/00; A01K 5/02; A01K 15/02; H04N 7/18

(52) U.S. Cl. CPC A01K 29/005; H04N 7/185; A01K 15/025; A01K 5/02

(57) ABSTRACT

The present invention relates to pet supplies technical field, more especially relates to a pet monitor. The pet monitor with a hollow shell, said shell is provided with a rotating unit, a feeding unit and a control unit; a camera and a laser pen is set in the rotating unit; the control unit includes a core board, a control board and a APP loaded on a mobile terminal; the camera takes images of pets and transmits them to the APP on the mobile terminal; user observes the images via the APP and sends a feeding or funny instruction to the control unit; the control unit receives the instructions to control the feeding unit to feed or to control the laser pen to light.

### FIELD OF THE INVENTION

The present invention relates to pet supplies technical field, more specifically relates to pet monitor.

### BACKGROUND OF THE INVENTION

Nowadays many families like to keep pets, especially dogs. People tend to build deep feelings when they spend time with their pets. Pets have become an indispensable member of many families in our country. Data shows that the number of pets in China has increased by nearly 900% between 2014 and 2018.

As the number of pets continues to rise, problems are gradually exposed. For example, when people go out, pets are lonely and bored in the room. The vast majority of pet products on the market at present do not address the negative emotions generated by pets when their owners are out of the house. When pets are prone to anxiety, irritability and other negative emotions, they will jump around and make random noises to disturb neighbors. Even pets produce certain aggression or damage to certain items. Serious conditions can lead to accidents and injuries to pets.

Therefore, how to properly and safely monitor, interact and feed pets becomes an urgent problem.

### SUMMARY OF THE INVENTION

In order to solve the technical problems, the present invention provides a pet monitor, which can realize remote monitoring of pets. When it detects that the pet produces negative emotions such as unease, irritability, etc., pet can be amused through remote voice calls, playing different sound effects, or interacting with a laser pen. The pet monitor also can automatically feed.

The present invention provides the following technical proposal: a pet monitor with a hollow shell. The shell is provided with a rotating unit, a feeding unit and a control unit. A camera and a laser pen is set in the rotating unit. The control unit includes a core board, a control board and a APP loaded on a mobile terminal. The camera takes images of the pets and transmits them to the APP on the mobile terminal. The user observes the pet image via APP and sends a feeding or funny instruction to the control unit. The control unit receives the instructions to control the feeding unit to feed or to control the laser pen to light. The pet monitor realizes the monitoring, tracking, funny and automatic feeding functions through the setting of the above parts, the pet can feel the care from the pet owner when the pet owner leave house.

Preferably, the rotating unit also includes a rotating component, which includes a rotating shell rotatable relative to the shell, a first motor that drives the rotating shell to rotate and is arranged in the shell, and a light touch switch that controls the rotation range of the rotating shell. The first motor, the light touch switch, the camera and the laser pen are electrically connected with the control board respectively. Under the control of the light touch switch, the first motor drives the rotating shell to rotate in a certain range, which realizes to find and track pets through the camera within the certain range, and at the same time to amuse pets through the laser pen.

Preferably, there is a slot in one side of the shell, the rotating unit is rotatably mounted at the slot. The cavity of the shell is provided with the feeding unit, the control unit and a horn. The core board of the control unit is electrically connected with the control board of the control unit. The core plate is electrically connected with the feeding unit and the horn. The control board is electrically connected with the rotating unit.

Preferably, the end face of the shell is provided with a groove, a cover covering the groove and connecting with the clip spring of the shell and the horn hole; a first through hole and a second through hole are respectively excavated on the bottom and circumferential surfaces of the grooves; the horn is located above the horn hole, and the audio emitted by the horn is distributed through the horn hole for interaction between the pet owner and the pet.

Preferably, the feeding unit includes a trap in the groove, a cover plate on the trap, and a tray funnel in the second through hole, a transmission rod connected with the tray and a second motor that drives the rotation of the transmission rod and is electrically connected to the core plate. The tray is divided into a plurality of isolation slot. The transmission rod passes through the first through hole and is clamped with the tray. The second motor drives the transmission rod to rotate so that the tray rotates relative to the groove.

Preferably, the feeding unit also includes a control component that controls the rotation of the transmission rod. The control component comprises a star member arranged on the transmission rod and a sensing component electrically connected with the core plate. The second motor drives the transmission rod to rotate so that the star member also rotates synchronously. When the star member is in the sensing range of the sensor, the second motor stops turning.

Preferably, the pet monitor also comprises a charging socket, a power source indicator light and a power switch; the charging socket, the power supply indicator light and the power switch are electrically connected with the control board.

The beneficial effects of the present invention are as follows: the pet owner can send a signal to the core board via the APP on the mobile terminal and control the rotating unit through the control board, the camera looks for, tracks and takes images of the pet and transmits the images of the pets to the APP on the mobile terminal. The pet owner observes the pet images through APP, interacts with the pet and appeases the pet through the horn broadcasting the audio signal of the pet owner. The pet owner also can send feeding or funny instructions to the control unit. The control unit receives the instructions to control the feeding unit or to control the laser pen. The pet monitor in the present invention realizes the monitoring, tracking, finny and automatic feeding functions, the pet can feel the care from the pet owner when the pet owner leave house.

### BRIEF DESCRIPTION OF THE DRAWINGS

FIG. 1 is a stereoscopic diagram of the pet monitor described in the present invention.

FIG. 2 is a decomposition diagram of the pet monitor in the present invention.

FIG. 3 is a decomposition diagram of the rotating unit of the pet monitor in the present invention.

### DETAILED DESCRIPTION OF ILLUSTRATED EMBODIMENTS

The follows will further descript the present invention with the embodiments, which are the preferable embodiments in the present invention.

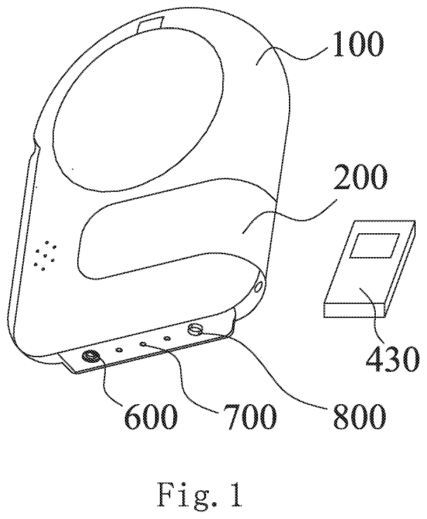

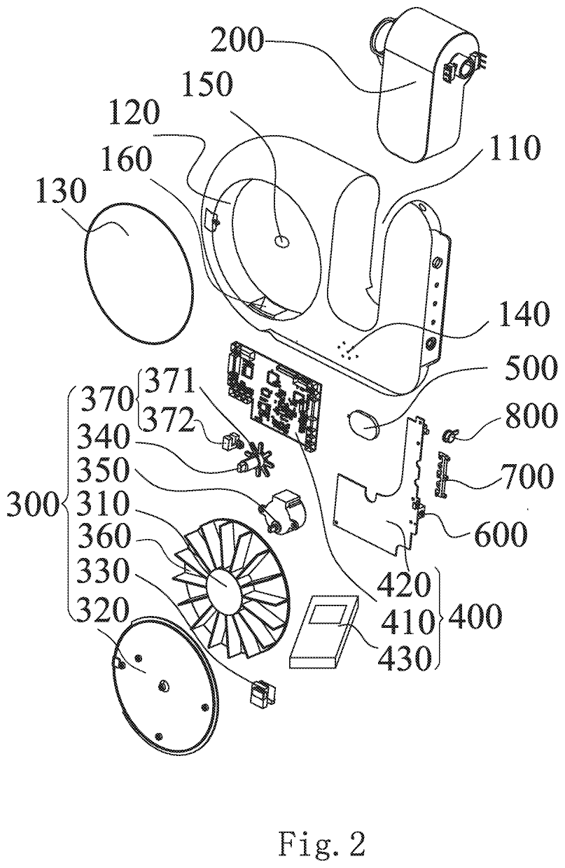

Referring to FIG. 1 and FIG. 2, a pet monitor with a hollow shell 100. The side of the shell 100 is provided with a slot 110. A rotating unit 200 is rotatably arranged at the slot 110. The cavity of the shell 100 is provided with a feeding unit 300, and a control unit 400 and a horn 500.

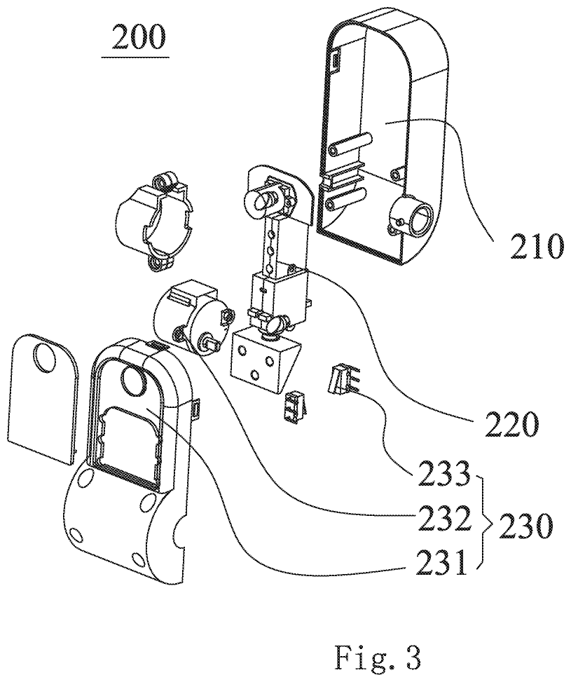

Referring to FIG. 2 and FIG. 3, the rotating unit 200 includes a camera 210 and a laser pen 220. The control unit 400 includes a core board 410, a control board 420 and a APP loaded on a mobile terminal 430. The camera 220 takes images of the pets and transmits them to the APP on the mobile terminal 430. The user observes the images of the pet via the APP and sends a feeding or funny instruction to the control unit 400. The control unit 400 receives the instructions to control the feeding unit 300 or to control the laser pen 220.

Preferably, referring to FIG. 1, the pet monitor also comprises a charging socket 600, a power source indicator light 700 and a power switch 800. The charging socket 600, the power supply indicator light 700 and the power switch 800 are electrically connected with the control board 420. When a pet needs to be accompanied or fed, the pet: owner can send a signal to the core board 410 via the APP on the mobile terminal 430. After receiving the signal, the core board 410 controls the rotating unit 200 to rotate through the control board 420 so as to facilitate the rotating unit 200 in finding, tracking, and photographing pets. Real-time monitoring can be fed back to the APP on the mobile terminal 430 via the core board 410. The pet owner sends an audio signal or an feeding instruction or funny instruction to the core board 410 through the APP on the mobile terminal 430 based on the pet's behavior. After receiving the signal, the core board 410 can send the audio signal of the pet owner through a horn 500 for the audio interaction between the pet owner and the pet, so as to facilitate the companionship and pacification of the pet, or send feeding instruction or funny instruction to the control unit 400. The control unit 400 receives instructions to control the feeding unit 300 for reward or the laser pen 220 for fun. The pet monitor in the present invention realizes the monitoring, tracking, funny and automatic feeding functions, the pet can feel the care from the pet owner when the pet owner leave house.

Referring to FIG. 3, the rotating unit 200 also includes a rotating component 230, the rotating component 230 includes a rotating shell 231 rotatable relative to the shell 100, a first motor 232 that drives the rotating shell 231 rotate and is arranged in the shell 231, and a light touch switch 233 that controls the rotation range of the rotating shell 231. The camera 210 and the laser pen 220 are arranged in the rotating shell 231. The first motor 232, the light touch switch 233, the camera 210 and the laser pen 220 are electrically connected with the control board 420, respectively. When the pet owner sends a signal to the core board 410 through the APP on the mobile terminal 430, the core board 410 detects the position through an optical couplet and outputs a signal to the control board 420. The control board 420 starts the first motor 232. The first motor 232 drives the rotating shell 231 to rotate within the limit range of the light touch switch 233, so that the pet can be found, tracked and photographed through the camera 210 within the certain range. While the core plate 410 transmits the rotation signal of the rotating shell 231 to the control plate 420, the control plate 420 further controls the motion of the steering gear connected with the laser pen 220, thereby causing the light projected by the laser pen 220 to move through the motion of the steering gear. It can attract the attention of pets, which is easy to find pets and forms a better interaction with pets.

Referring to FIG. 2 and FIG. 3, the core board 410 of the control unit 400 is electrically connected with the control board 420 of the control unit 400, the core board 410 is electrically connected with the feeding unit 300 and the horn 500, and the control board 420 is electrically connected with the rotating unit 200.

Referring to FIG. 2 and FIG. 3, the end face of the shell 100 is provided with a groove 120, the cover 130 covering the groove 120 and connecting with the clip spring of the shell 100 and the horn hole 140. The first through hole 150 and the second through hole 160 are respectively excavated on the bottom and circumferential surfaces of the grooves 120. The horn 500 is located above the horn hole 140, and the audio emitted by the horn 500 is distributed through the horn hole 140 for interaction between the pet owner and the pet.

Further, the feeding unit 300 includes a trap 310 in the groove 120, a cover plate 320 on the trap 120, and a tray funnel 330 in the second through hole 160, a transmission rod 340 connected with the tray 310 and a second motor 350 that drives the transmission rod 340 to rotate and is electrically connected to the core plate 410. There are a plurality of isolation grooves 360 on the tray 310. The transmission rod 340 passes through the first through hole 150 and is clamped with the tray 310. The second motor 350 drives the transmission rod 340 to rotate so that the tray 310 rotates relative to the groove 120. Food for pets is placed in the isolation grooves 360. With the rotation of the trap 310, the food also rotates within the groove 120.

Further, the feeding unit 300 also includes a control component 370 that controls the rotation of the transmission rod 340. The control component 370 comprises a star member 371 arranged on the transmission rod 340 and a sensing component 372 electrically connected with the core plate 410. When the pet performs well, the pet owner can send a signal to the core board 410 via the APP on the mobile terminal 430. After receiving the signal, the core board 410 starts the second motor 350, and the second motor 350 drives the transmission rod 340 to rotate, so that the star number 371 also rotates with the synchronization. When the isolation slot 360 is opposite to the second through hole 160, the food stored in the isolation slot 360 falls through a tray funnel 330. When the extension of the star number 371 is in the sensing range of the sensing component 372, the second motor 350 stops rotating. The second motor drives the transmission rod to rotate so that the star member also rotates synchronously. Repeat the above process when the pet is needed to feed again.

The working principle of the present invention is as follow: Place the food in the isolation slot 360 before the user goes out, turn on the power switch 800 so that the power supply indicator light 700 is in working state. The user sends a signal to the core board 410 after automatically connecting the pet monitor with the APP on the mobile terminal 430. The core board 410 detects the position by optical coupling and outputs signals to the control board 420. The control board 420 starts the first motor 232. The first motor 232 drives the rotating shell 231 to rotate within the limit range of the light touch switch 233, so that the pet can be found, tracked and photographed through the camera 210 within the limited range. While the core plate 410 transmits the rotation signal of the rotating shell 231 to the control plate 420, the control plate 420 further controls the motion of the steering gear connected with the laser pen 220, thereby causing the light projected by the laser pen 220 to move through the motion of the steering gear. It can attract the attention of pets and forms a better interaction with pets. In addition, real-time monitoring can be fed back to the APP on the mobile terminal 430 through the core board 410. According to the specific behavior of the pet, the user sends a signal to the core board 410 through the APP on the mobile terminal 430. After receiving the signal, the core board 410 can send the audio signal of the user through the horn 500 to realize the audio interaction between the user and the pet and to accompany and appease the pet. At the same time, the core plate 410 starts the second motor 350 to drive the transmission rod 340 so that the star part 371 also rotates with the synchronization. When the isolation slot 360 is opposite to the second through hole 160, the food stored in the isolation slot 360 falls down through the tray funnel 330, thus realizing the reward feeding to the pet.

The above content is a further detailed explanation of the present invention in combination with the specific optimal implementation mode, and it cannot be assumed that the concrete implementation of the present invention is limited to these instructions only. For the person having ordinary skill in the art, the structure form of the present invention can be flexible and changeable, and a series of products can be derived without departing from the concept of the present invention. A number of simple deductions or replacements shall be deemed to fall within the scope of patent protection determined by the submitted claims.

What is claimed is:

1. A pet monitor, wherein said pet monitor with a hollow shell, said shell is provided with a rotating unit, a feeding unit and a control unit; a camera and a laser pen is set in said rotating unit; said control unit includes a core board, a control board and a APP loaded on a mobile terminal; said camera takes images of pets and transmits them to said APP on said mobile terminal; user observes said images via said APP and sends a feeding or funny instruction to said control unit; said control unit receives said instructions to control said feeding unit to feed or to control said laser pen to light.

2. The pet monitor according to claim 1, wherein said rotating unit also includes a rotating component, which includes a rotating shell rotatable relative to said shell, a first motor that drives said rotating shell to rotate and is arranged in said shell, and a light touch switch that controls said rotating range of said rotating shell; said first motor, said light touch switch, said camera and said laser pen are electrically connected with said control board respectively; under the control of said light touch switch, said first motor drives said rotating shell to rotate in a certain range.

3. The pet monitor according to claim 1, wherein there is a slot in one side of said shell, said rotating unit is rotatably mounted at said slot; the cavity of said shell is provided with said feeding unit, said control unit and a horn; said core board of said control unit is electrically connected with said control board of said control unit; said core plate is electrically connected with said feeding unit and said horn; said control board is electrically connected with said rotating unit.

4. The pet monitor according to claim 3, wherein the end face of said shell is provided with a groove, a cover covering said groove and connecting with a clip spring of said shell and a horn hole; a first through hole and a second through hole are respectively excavated on the bottom and the circumferential surfaces of said grooves; said horn is located above said horn hole, and audio emitted by said horn is distributed through said horn hole.

5. The pet monitor according to claim 4, wherein said feeding unit includes a trap in said groove, a cover plate on said trap, and a tray funnel in said second through hole, a transmission rod connected with said tray and a second motor that drives said transmission rod and is electrically connected to said core plate; said tray is divided into a plurality of isolation slot; said transmission rod passes through said first through hole and is clamped with said tray; said second motor drives said transmission rod to rotate so that said tray rotates relative to said groove.

6. The pet monitor according to claim 5, wherein the feeding unit also includes a control component that controls the rotation of said transmission rod; said control component comprises a star member arranged on said transmission rod and a sensing component electrically connected with said core plate; said second motor drives said transmission rod to rotate so that said star member also rotates synchronously; when said star member is in the sensing range of said sensor, said second motor stops turning.

7. The pet monitor according to claim 4, wherein said pet monitor also comprises a charging socket, a power source indicator light and a power switch; said charging socket, said power supply indicator light and said power switch are electrically connected with said control board.
